(19) United States
(12) Patent Application Publication
(10) Pub. No.: US 2012/0148181 A1
(43) Pub. Date: Jun. 14, 2012

(54) Wheel Bearing

(75) Inventors: Yasuhiro ARITAKE, Iwata-shi (JP); Kazuo KOMORI, Iwata-shi (JP)

(73) Assignee: NTN Corporation, Osaka (JP)

(21) Appl. No.: 13/327,846

(22) Filed: Dec. 16, 2011

Related U.S. Application Data
(63) Continuation of application No. PCT/JP2010/060178, filed on Jun. 16, 2010.

(30) Foreign Application Priority Data
Jun. 18, 2009 (JP) 2009-145466

(51) Int. Cl. F16C 33/58; B24B 1/00; F16C 19/02

(52) U.S. Cl. 384/512; 451/28

(57) ABSTRACT

A wheel bearing has an outer member and a pair of inner rings. Double row balls are freely rollably contained between the outer and inner raceway surfaces, via cages, of the outer member and inner rings. A counter portion is formed near a groove bottom of the inner raceway surface. The counter portion has a diameter larger than a groove bottom diameter by a predetermined clearance. The counter portion is formed by a cylindrical portion and a tapered portion. The cylindrical portion axially extends from the inner raceway surface. The tapered portion reduces from the cylindrical portion toward a smaller end face of the inner ring. A transition portion, between the counter portion and the inner raceway surface, is smoothly formed by an arc with a radius of curvature 2.0-10.0 mm.

### CROSS-REFERENCE TO RELATED APPLICATIONS

This application is a continuation of International Application No. PCT/JP2010/060178, filed Jun. 16, 2010, which claims priority to Japanese Application No. 2009-145466, filed Jun. 18, 2009. The disclosures of the above applications are incorporated herein by reference.

### FIELD

The present disclosure relates to a wheel bearing that freely rotationally supports a wheel of vehicle, such as an automobile and, more particularly, to a wheel bearing that prevents the formation of gauges or scratches on the balls, improve its acoustic properties and its life.

### BACKGROUND

Conventionally, wheel bearing apparatus that supports a wheel of a vehicle that freely rotationally supports a wheel hub that mounts a wheel, via a rolling bearing, and the wheel bearing apparatus include those for a driving wheel and those for a driven wheel. Considering the structure of the apparatus, in general, the inner ring rotation type is used for a driving wheel. Both the inner ring rotation type and the outer ring rotation type are used for a driven wheel. Double row angular contact ball bearings with low rotational torque characteristics are popularly adopted in wheel bearing apparatus that have desirable bearing rigidity, exhibit high durability against misalignment and improve fuel efficiency. In the double row angular contact ball bearing, a plurality of balls is interposed between a secured ring and a rotational ring. The balls contact the rings while applying a predetermined contact angle to the balls.

The wheel bearing apparatus are classified broadly into a first, second or third generation types. In the first generation type, a wheel bearing includes a double row angular contact ball bearing, etc. fit between a knuckle, that forms part of a suspension apparatus, and a wheel hub. The second generation type includes a body mounting flange or a wheel mounting flange directly formed on the outer circumference of an outer member (outer ring). The third generation type includes one inner raceway surface directly formed on the outer circumference of the wheel hub.

In recent years, there has been strong desires to improve acoustic properties such as “NVH”, i.e. “Noise”, “Vibration” and “Harshness,” let alone to improve the durability and provide a reduction in manufacturing cost. As shown in FIG. 8, a prior art wheel bearing 50 used in the wheel bearing apparatus is formed with a double row angular contact ball bearing. The wheel bearing 50 includes an outer ring 51 and a pair of inner rings 52, 52. The outer ring 51, on its inner circumference, includes double row outer raceway surfaces 51a, 51a. The pair of inner rings 52, 52 each includes, on its outer circumference, an inner raceway surface 52a opposing one of the double row outer raceway surfaces 51a, 51a. Double row balls 53, 53 are contained between the outer and inner raceway surfaces. Cages 54 rollably hold the double row balls 53, 53. Seals 55, 56 are mounted in annular openings formed between the outer ring 51 and the inner rings 52. The seals 55, 56 prevent leakage of lubricating grease sealed within the bearing and the entry of rain water or dust into the bearing from the outside.

Such a wheel bearing 50 is also called a first generation type and is shown in FIG. 9 formed with a counter portion (ridge) 57 near a groove bottom of the inner raceway surface 52a of the inner ring 52. The counter portion 57 has an outer diameter d2 larger than a groove bottom diameter d1. This prevents the inner ring 52 from falling out from the wheel bearing 50 after its assembly. This arrangement makes it possible to prevent the balls 53 from interfering with the counter portion 57 and falling out from the inner ring 52. That is, an outer diameter d2 of the counter portion 57 of the inner ring 52 is larger than an inscribed circle diameter of the balls d0 in a condition where the balls 53 are contained in the groove bottom of the outer raceway surface 51 a of the outer ring 51. Thus, a so called “ball lock-in height” (hereinafter simply referred to as “clearance”) 2δ is formed between the diameters “d2” and “d0”.

In addition, the outer circumference of a shoulder 52b of the inner ring 52, the inner raceway surface 52a , the counter portion 57 and a smaller end face 52c are simultaneously ground by a formed grinding wheel. This makes it possible to minimize the dimensional variation and limit the clearance 2δ and the “core distance L” (i.e. a distance from the groove bottom of the inner raceway surface 52a to the smaller end face 52c ) within a predetermined standardized value in order to minimize the initial gap setting and variations of bearing pre-pressure (see e.g. Japanese Laid-open Patent Publication No. 193745/2001).

In a general single row angular contact ball bearing, if the clearance 2δ is small, assembly of the bearing is made easy, whereas the inner ring can easily fall out. On the other hand, if the clearance 2δ is large, assembly of the bearing will be difficult and ball scratches (scratches caused during press fitting process over the clearance) are caused. In the prior art wheel bearing 50, the inner raceway surface 52a of the inner ring 52 and the counter portion 57 etc. are ground by a formed grinding wheel. Thus, both the clearance 2δ and the core distance L are limited within predetermined standardized values. Accordingly, it is possible to minimize the initial gap setting and reduce the pre-pressure variations. This prevents the generation of ball scratches caused during assembly of the bearing and fall out of the inner ring 52 after assembly of the bearing.

However, in the prior art wheel bearing 50, the balls 53 tend to be contacted against the edge of the counter portion 57 during transport of the bearing and assembly in the factory of the automobile manufacturer. The gouges may be caused on the balls 53 when the balls 53 contact against the counter portion 57 by impact loads due to excessive vibration. In addition, the balls 53 are sometimes scratched when the counter portion 57, formed with a straight shape, passes under the radially inner side of the balls 53 during assembly of the bearing. Since these scratches deteriorate the acoustic properties and detract from the life of the wheel bearing, an assembling method without causing scratches on the balls has been adopted that increases the cost of manufacturing the wheel bearing.

The present applicant has proposed a wheel bearing shown in FIG. 10. The inner ring 58 of the bearing apparatus is formed with a counter portion 59 near the groove bottom of an inner raceway surface 52. The counter portion has a predetermined axial width and a diameter larger than a groove bottom diameter d1. The counter portion 59 includes a cylindrical portion 59a and a tapered portion 59b. The cylindrical portion 59a extends axially from the inner raceway surface 52a . The tapered portion 59b is tapered from the cylindrical portion 59a toward the smaller end face 52c which continues to a smaller diameter portion 60. The outer diameter d2 of the counter portion 59 is set so that it is larger than the inscribed circle diameter d0 of the balls 53 in a condition where the balls 53 are contained in the groove bottom of the outer raceway surface 51a by a predetermined clearance 2δ″ (d2=d0+2δ). The inclination angle 0 is set at 5° or less. A transition portion A, between the inner raceway surface 52a and the counter portion 59, is formed by an arc having a predetermined radius of curvature R. A corner portion, between the cylindrical portion 59a of the counter portion 59 and the tapered portion 59b, is rounded by an arc and smoothly and continuously formed. The inclination angle 0 allows the balls 53 to be smoothly guided from the tapered portion 59b to the cylindrical portion 59a. Thus, this suppresses the generation of scratches on the balls 53 during the assembly of the bearing. In addition, the transition A, formed as an arc of predetermined radius of curvature R, can prevent the generation of burrs etc. as well as scratches on balls caused by the clearance during assembly of the inner ring 58. Furthermore, it is possible to improve the acoustic properties and the life of wheel bearing since contact of balls 53 against the counter portion 59 is prevented during transport of the bearing and assembling steps in the factory of automobile manufacturer. (See, Japanese Laid-open Patent Publication No. 2007/085371).

In the wheel bearing apparatus of the third generation type, the inner ring 58 does not contact against balls 53 even if a vibration is applied to the bearing apparatus during its transportation. The bearing apparatus is transported under a condition where the inner ring 58 is press-fit into the wheel hub. However, especially in the wheel bearing apparatus of the first or second generation type, the transition portion A, between the inner raceway surface 52a and the counter portion 59, is formed by an arc with a predetermined radius of curvature R. Thus, it is possible to prevent the generation of burrs on the inner ring 58. However, the balls 53 may be damaged by the repeated contact between the transition portion A and balls 53 caused by vibration during transportation, if the radius of curvature R is small. If the depth of damages on the balls 53 is large, an edge load (excessive load) is caused when the balls 53 roll on the inner raceway surface 52a . Thus, the life of the bearing is reduced. Accordingly, it is important and required to suppress the generation of damage on the balls.

### SUMMARY

It is, therefore, an object of the present disclosure to provide a wheel bearing that prevents the generation of damages, such as scratches and gouges, to improve the acoustic properties and the life of the wheel bearing.

To achieve the object of the present disclosure, a wheel bearing comprises an outer member and a pair of inner rings. The outer member, on its inner circumference, includes double row outer raceway surfaces. The pair of inner rings, each formed with an inner raceway surface on its outer circumference, is arranged opposite to one of the double row outer raceway surfaces. Double row balls are freely rollably contained between the outer and inner raceway surfaces, via cages. A counter portion is formed near a groove bottom of the inner raceway surface. The counter portion has a diameter larger than a groove bottom diameter by a predetermined clearance. The counter portion is formed by a cylindrical portion and a tapered portion. The cylindrical portion axially extends from the inner raceway surface. The tapered portion reduces from the cylindrical portion toward a smaller end face of the inner ring. A transition portion, between the counter portion and the inner raceway surface, is smoothly formed by an arc having a radius of curvature 2.0-10.0 mm.

The wheel bearing includes a double row angular contact ball bearing. A counter portion is formed near a groove bottom of the inner raceway surface. The counter portion has a diameter larger than a groove bottom diameter by a predetermined clearance. The counter portion is formed by a cylindrical portion and a tapered portion. The cylindrical portion axially extends from the inner raceway surface. The tapered portion reduces from the cylindrical portion toward a smaller end face of the inner ring. A transition portion, between the counter portion and the inner raceway surface, is smoothly formed by an arc with a radius of curvature 2.0-10.0 mm. Thus, it is possible to provide a wheel bearing that prevents the generation of deep damage on the balls. This improves the acoustic properties and the life of the wheel bearing even if the balls are repeatedly contacted against by the transition portion when vibrations are applied to the wheel bearing during transportation.

The clearance of the counter portion is set within a range of 30-90 μm. This makes it possible to keep a sufficient coming-out preventing force even if impact loads are applied to the inner ring. Also, this enables to carry out efficient assembly of the wheel bearing without causing reduction of the hardness of the outer ring of the bearing.

A transition portion between the cylindrical portion of the counter portion and the corner portion of the tapered portion is smoothly formed by an arc. The inclined angle of the tapered portion is set at an angle of 5° or less. This makes it possible to smoothly lead the balls from the tapered portion to the cylindrical portion. Thus, this suppresses the generation of scratches on the balls during the assembly of the inner ring.

The counter portion is simultaneously integrally ground with the inner raceway surface by a formed grinding wheel. This makes it possible to form a smooth counter portion with no corner. Thus, this surely prevents the generation of burrs etc.

The larger outer circumference and the smaller end face of the inner ring are simultaneously ground by a formed grinding wheel. This makes it possible to exactly form the core distance from the groove bottom of inner raceway surface to the smaller end face within a predetermined standardized value. Thus, this reduces the variation of the bearing pre-pressure by minimizing the initial gap setting of the bearing.

A counter portion, with an inner diameter slightly smaller than a grove bottom diameter, is formed on the outer member at a position spaced apart a predetermined distance from a groove bottom of the outer raceway surface. The inner diameter of the counter portion is set within a range so that balls held by the cages will not fall out from the cages due to reduction of a circumscribed circle diameter of the balls. A transition portion, between the counter portion and the outer raceway surface, is smoothly formed by an arc having a radius of curvature of 2.0-10.0 mm. This makes it possible to prevent the generation of burrs and the generation of deep damage on the balls. Thus, this improves the acoustic properties and the life of the wheel bearing even if the balls are repeatedly contacted against the transition portion when vibrations are applied to the wheel bearing during its transportation.

The counter portion is simultaneously integrally ground with the outer raceway surfaces by a formed grinding wheel. This makes it possible to form a smooth counter portion with no corner. Thus, this surely prevents the generation of burrs etc. and scratches on the balls during assembly of the wheel bearing.

The outer raceway surfaces and the inner circumference are simultaneously ground by a formed grinding wheel. This makes it possible to smoothly form the transition portion, to improve the exactness of coaxiality of the double row outer raceway surfaces, inner diameter and counter portion. This assures a desirable groove height to prevent the riding over of the balls and thus a predetermined life of the bearing.

The wheel bearing of the present disclosure includes an outer member and a pair of inner rings. The outer member includes double row outer raceway surfaces on its inner circumference. The pair of inner rings, each formed on its outer circumference with an inner raceway surface, is arranged opposite to one of the double row outer raceway surfaces. Double row balls are freely rollably contained between the outer and inner raceway surfaces, via cages. A counter portion is formed near a groove bottom of the inner raceway surface. The counter portion has a diameter larger than a groove bottom diameter by a predetermined clearance. The counter portion is formed by a cylindrical portion and a tapered portion. The cylindrical portion axially extends from the inner raceway surface. The tapered portion reduces from the cylindrical portion toward a smaller end face of the inner ring. A transition portion, between the counter portion and the inner raceway surface, is smoothly formed with an arc having a radius of curvature 2.0-10.0 mm. Thus, it is possible to provide a wheel bearing that prevents the generation of deep damage on the balls. Thus, this improves the acoustic properties and the life of the wheel bearing even if the balls are repeatedly contacted against the transition portion when vibrations are applied to the wheel bearing during its transportation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a first embodiment of the wheel bearing apparatus.

FIG. 2 is a longitudinal section view of the wheel bearing of FIG. 1.

FIG. 3(a) is a partially enlarged cross-section view of the inner ring of FIG. 2.

FIG. 3(b) is an enlarged view of FIG. 3(a).

FIG. 4 is an explanatory view of a grinding process of the inner ring.

FIG. 5 is a graph of a relationship between the clearance and the coming-out preventing force.

FIG. 6(a) is an enlarged cross-section view of the outer ring of FIG. 2.

FIG. 6(b) is a further enlarged cross-section view of FIG. 6(a).

FIG. 7 is an explanatory view of a grinding process for the outer ring.

FIG. 8 is a longitudinal section view of a prior art wheel bearing.

FIG. 9 is a partially enlarged cross-section view of the inner ring of FIG. 8.

FIG. 10(a) is a partially enlarged cross-section view of the inner ring of the prior art.

FIG. 10(b) is a further enlarged cross-section view of FIG. 10(b).

### DETAILED DESCRIPTION

A mode for carrying out the present disclosure is a wheel bearing including an outer ring and a pair of inner rings. The outer ring includes double row outer raceway surfaces on its inner circumference. The pair of inner rings, each formed on its outer circumference with an inner raceway surface, is arranged opposite to one of the double row outer raceway surfaces. Double row balls are freely rollably contained between the outer and inner raceway surfaces, via cages. A counter portion is formed near a groove bottom of the inner raceway surface. The counter portion has a diameter larger than a groove bottom diameter by a predetermined clearance. The counter portion is formed by a cylindrical portion and a tapered portion. The cylindrical portion axially extends from the inner raceway surface. The tapered portion reduces from the cylindrical portion toward a smaller end face of the inner ring. A transition portion between, the counter portion and the inner raceway surface, is smoothly formed by an arc with a radius of curvature 2.0-10.0 mm. The transition portion is simultaneously integrally ground with the inner raceway surface by a formed grinding wheel.

A preferable embodiment of the present disclosure will be hereinafter described with reference to the drawings.

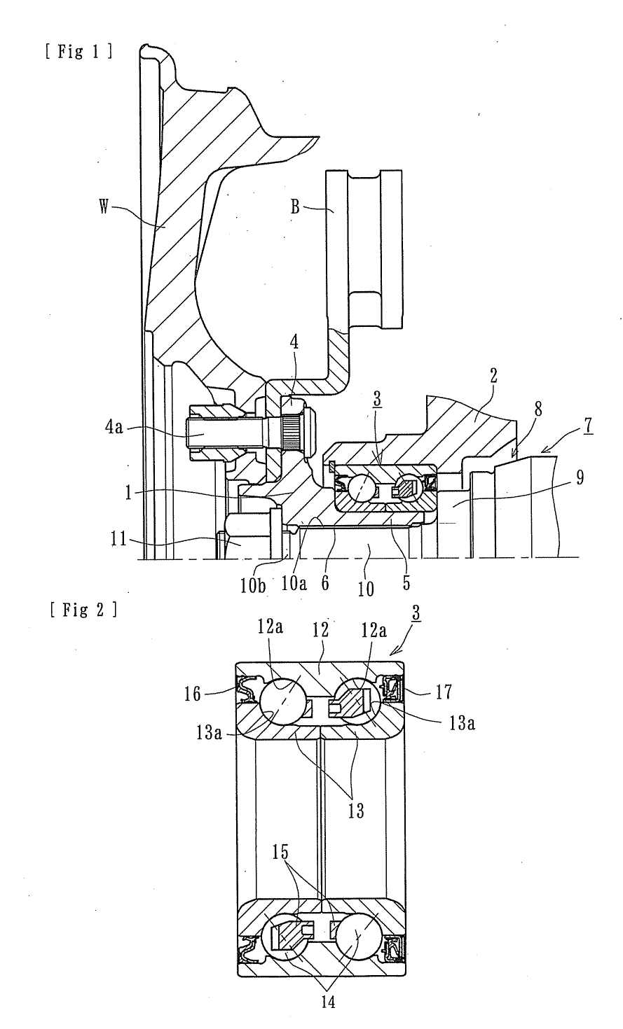

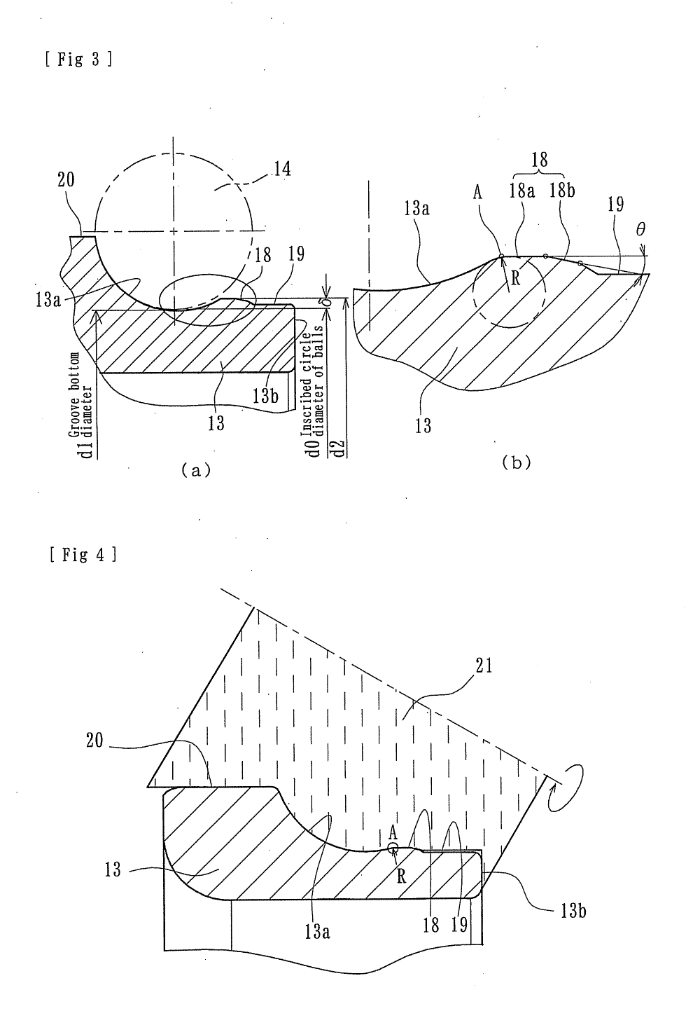

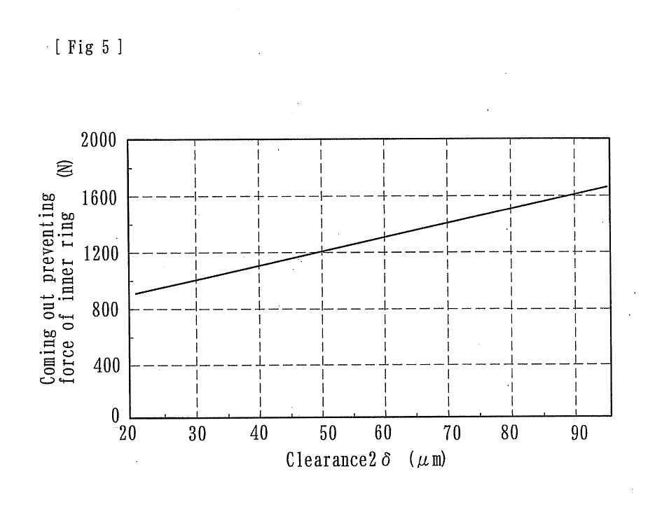

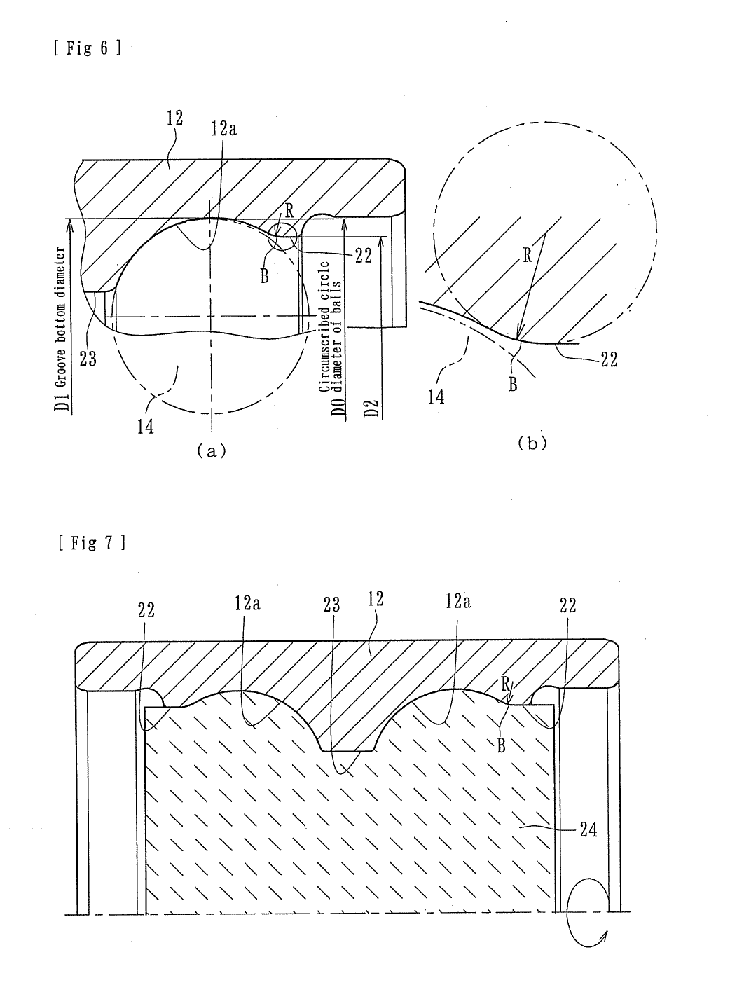

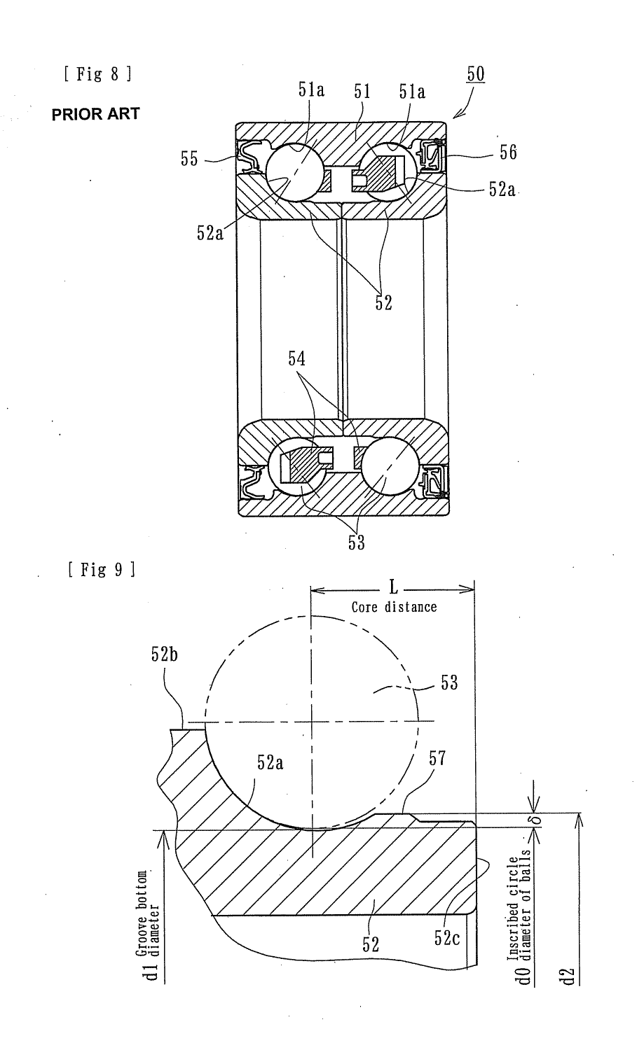

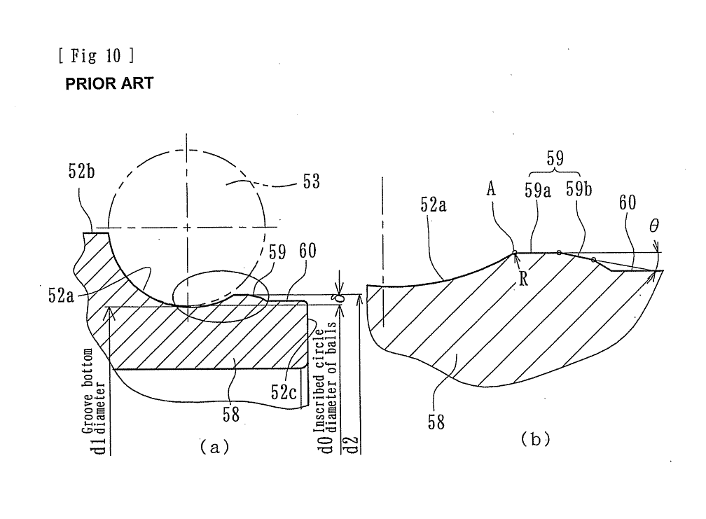

FIG. 1 is a longitudinal cross-section view of a first embodiment of the wheel bearing apparatus. FIG. 2 is a longitudinal cross-section view of the wheel bearing of FIG. 1. FIG. 3(a) is a partially enlarged cross-section view of the inner ring groove of FIG. 2. FIG. 3(b) is a further enlarged cross-section view of FIG. 3(a). FIG. 4 is an explanatory view of a grinding process of the inner ring. FIG. 5 is a graph of a relationship between the clearance and the coming-out preventing force. FIG. 6(a) is an enlarged cross-section view of the outer ring of FIG. 2. FIG. 6(b) is a further enlarged cross-section view of FIG. 6(a). FIG. 7 is an explanatory view of a grinding process of the outer ring. In the description of the present disclosure, an outer side of the wheel bearing apparatus, when it is mounted on a vehicle, is referred to as the “outer side” (left side in drawings). An inner side of the bearing apparatus, when it is mounted on a vehicle, is referred to as the “inner side” (right side in drawings).

The illustrated wheel bearing apparatus is a so-called first generation type. It is used for a driving wheel. The bearing apparatus includes a wheel hub 1 and a wheel bearing 3 press fit onto the wheel hub 1. The wheel bearing 3 is adapted to rotatably support the wheel hub 1 relative to the knuckle 2. The wheel hub 1 includes a wheel mounting flange 4 on its outer side end. The wheel mounting flange 4 mounts a wheel W. A cylindrical portion 5 axially extends from the wheel mounting flange 4. Hub bolts 4a, for mounting the wheel W, and a brake rotor B are also arranged on the wheel mounting flange 4 equidistantly along its periphery. The wheel hub 1 includes serrations or splines 6 on its inner circumference. The serration (or spline) 6 transmits torque. The wheel bearing 3 is press fit onto the outer circumference of the cylindrical portion 5.

The wheel hub 1 is made of medium carbon steel including carbon of 0.40-0.80% by weight such as S53C. It is hardened by high frequency induction hardening so that a region from an inner side base of the wheel mounting flange 4 to the cylindrical portion 5 has a surface hardness of 50-64 HRC. This makes it possible to apply a sufficient mechanical strength against a rotary bending load, applied to the wheel mounting flange 4. Thus, this improves the anti-fretting property of the cylindrical portion 5 onto which the wheel bearing 3 is press fit.

The wheel bearing 3 is secured on the wheel hub 1 by being sandwiched between a shoulder 9 of an outer joint member 8, which forms a constant velocity universal joint 7, and the wheel hub 1. The outer joint member 8 is integrally formed with a stem portion 10 that extends axially from the shoulder portion 9. The stem portion 10 is formed on its outer circumference with a serration (or spline) mating with the serration 6 of the wheel hub 1. The stem portion 10 is also formed with a male thread 10b . A torque from an engine is adapted to be transmitted to the wheel hub 1 via a drive shaft (not shown), the constant velocity universal joint 7 and the serration 10a of the stem portion 10 of the constant velocity universal joint 7. In addition, a predetermined bearing pre-pressure is applied to the wheel bearing 3 by fastening a securing nut 11 onto the male thread 10b of the stem portion by a predetermined fastening torque.

As shown in the enlarged view of FIG. 2, the wheel bearing 3 includes an outer ring (outer member) 12, a pair of inner rings 13, 13 fit into the outer ring 12, and double row balls 14, 14 contained, between the outer ring 12 and the inner ring 13. The wheel bearing 3 is formed as a double row angular contact bearing of the back-to-back duplex type. The front side end faces of the pair of the inner rings 13, 13 abut each other.

The outer ring 12 is formed of high carbon chrome steel such as SUJ 2 with double row outer raceway surfaces 12a, 12a formed on its inner circumference. Each inner ring 13 is also formed of high carbon chrome steel such as SUJ 2. The inner rings 13 include inner raceway surfaces 13a formed on its outer circumference. The inner raceway surface 13a is adapted to be arranged opposite to one of the outer raceway surfaces 12a, 12a. The double row balls 14, 14 are also formed of high carbon chrome steel such as SUJ 2. The balls 14, 14 are contained between the outer and inner raceway surfaces 12a, 13a and held therein by cages 15, 15. Seals 16, 17 are mounted on both ends of the wheel bearing 3. The seals 16, 17 prevent leakage of grease contained in the bearing and entry of rain water and dust into the bearing from the outside.

As shown in the enlarged view of FIG. 3 the inner ring 13 is formed, on its outer circumference, with a counter portion 18 near the groove bottom of the inner raceway surface 13a. The counter portion 18 has a predetermined width and a diameter slightly larger than a diameter d1 of the groove bottom. The counter portion 18 is formed by a cylindrical portion 18a and a tapered portion 18b. The cylindrical portion 18a axially extends from the inner raceway surface 13a. The tapered portion 18b reduces from the cylindrical portion 18a toward a smaller end face 13b of the inner ring 13. The tapered portion continues into a cylindrical portion 19 of a further reduced diameter. A transition portion (corner portion), between the cylindrical portion 18a of the counter portion 18 and the tapered portion 18b, is smoothly formed by an arc.

The outer diameter d2 of the counter portion 18 is set so that it is larger than the inscribed circle diameter d0 of the balls 14 in a condition where the balls 14 are contained in the groove bottom of the outer raceway surface 12a by a predetermined clearance 2δ″ (d2=d0+2δ). The inclination angle θ is set at 5° or less. The inclined angle θ of the tapered portion 18b is set at an angle of 5° or less. The inclination angle θ allows the balls 14 to be smoothly guided from the tapered portion 18b to the cylindrical portion 18a. This suppresses the generation of scratches on the balls 14 during the assembly of the bearing.

According to the present disclosure, a transition portion A between the inner raceway surface 13a and the counter portion 18 is formed by an arc with a predetermined radius of curvature R. The transition portion A is simultaneously ground with the inner raceway surface 13a by a formed grinding wheel 21 (FIG. 4). This makes it possible to limit the outer diameter d2 of the counter portion 18 within a predetermined standardized value in order to set the clearance 2δ of the counter portion 18 within a predetermined tolerance. Also, it is possible to form the configuration and dimension of the counter portion 18 exactly and smoothly. In addition, as shown in FIG. 4, if the larger outer diameter 20, the counter portion 18 and the smaller end face 13b are ground simultaneously with the inner raceway surface 13a, by the formed grinding wheel 21, the “core distance”, i.e. a distance from the groove bottom of the inner raceway surface 13a to the smaller end face 13b, can be exactly formed within a predetermined standardized value. This minimizes the initial gap setting and variations of bearing pre-pressure.

The present applicant made several samples with different radius of curvatures R of the transition portion A between the inner raceway surface 13a and the counter portion 18. A damage generation test was carried out by applying a vibration to the wheel bearings and a verified relationship between the radius of curvature R and size of damages caused on the balls 14. Results of the test are shown in Table 1.

TABLE 1

| | Radius of curvature of | | |
|---|---|---|---|
| No. | transition portion | Clearance 2δ | Depth of ball damage |
| 1 | 0.2 mm | 30 μm | 2.5 μm |
| 2 | 0.5 mm | 110 μm | 2.5 μm |
| 3 | 2.0 mm | 30 μm | 0.8 μm |
| 4 | 5.0 mm | 90 μm | 0.8 μm |
| 5 | 10.0 mm | 110 μm | 0.8 μm |
| 6 | 12.0 mm | 110 μm | 0.8 μm |

As can be seen from Table 1, it is possible to reduce the depth of damage of the balls 14 by setting the radius of curvature R of the transition portion A at 2.0 mm or more. The cylindrical portion 18a is shortened if the radius of curvature R exceeds 10.0 mm. This is undesirable. Thus, the radius of curvature R of the transition portion A is set within a range of 2.0-10.0 mm. This makes it possible to prevent the generation of burrs etc. and to extremely exactly machine the outer diameter d2 of the counter portion 18 by simultaneous grinding. In addition, it is possible to provide a wheel bearing that can prevent the generation of deep damage onto the balls. Thus, this improves the acoustic properties and the life of the wheel bearing even if the balls 14 are repeatedly contacted against the transition portion A when vibrations are applied to the wheel bearing during its transportation.

The relationship between the clearance 2δ of the counter portions and the coming-out preventing force of the inner ring 13 is shown in a graph of FIG. 5. A larger clearance 2δ is effective when considering merely a coming-out preventing force of the inner ring 13. However, it is necessary to increase the heating temperature of the outer ring 12 if the clearance 2δ is larger in order to prevent the balls 14 from being contacted by the counter portion 18 of the inner ring 13 during assembly of the wheel bearing. This increases the cycle time of assembly and causes reduction of the hardness of the outer ring 12. Thus, this is undesirable. The clearance 2δ is set within a range 30-90 μm according to the present disclosure. This makes it possible to assure a sufficient coming-out preventing force even if a large acceleration is generated in the inner ring 13 by an impact load applied to it. Thus, it is possible to carry out the efficient assembly of the bearing without causing hardness reduction of the outer ring 12.

The outer ring 12 is formed with a counter portion 22 with an inner diameter D2 slightly smaller than a grove bottom diameter D1. The counter portion 22 is at a position spaced apart a predetermined distance from a groove bottom of the outer raceway surface 12a, as shown in an enlarged view of FIG. 6. The inner diameter D2 of the counter portion 22 is set within a range so that balls 14 held by the cages (not shown) do not climb over the counter portion 22. Thus, the balls do not fall out from the cages due to a reduction of a circumscribed circle diameter DO of the balls 14.

A transition portion B between the outer raceway surface 12a and the counter portion 22 is continuously and smoothly formed by an arc. The arc has a radius of curvature of 2.0-10.0 mm similarly to the inner ring 13. This makes it possible to prevent the generation of burrs and the generation of deep damage on the balls 14. Thus, this improves the acoustic properties and the life of the wheel bearing even if the balls 14 are repeatedly contacted against the transition portion B when vibrations are applied to the wheel bearing during its transportation.

As shown in FIG. 7, the counter portion 22 is integrally simultaneously ground with the outer raceway surfaces 12a, 12a by a formed grinding wheel 24. This makes it possible to smoothly form the transition portion B, to prevent the generation of scratches on the balls 14 during assembly of the wheel bearing. This improves the exactness of coaxiality of the double row outer raceway surfaces 12a, 12a, inner diameter 23 and counter portion 22. This assures a desirable groove height to prevent shoulder riding over of the balls. Thus, this assures a predetermined life of the bearing. In this specification the term “shoulder riding over” means a phenomenon where a so-called edge load is generated by a contacting ellipse formed in the contacting portions between the balls 14 and the outer raceway surface 12a and protruding from a corner between the inner diameter 23 and the outer raceway surface 12a.

The wheel bearing can be applied to wheel bearing apparatus of the first or second generation type irrespective of whether it is used for a driving wheel or a driven wheel.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A wheel bearing comprising:
an outer member with double row outer raceway surfaces formed on its inner circumference;
a pair of inner rings, each inner ring formed with an inner raceway surface on its outer circumference, each inner raceway surface is arranged opposite to one of the double row outer raceway surfaces;
double row balls are freely rollably contained between the outer and inner raceway surfaces, via cages;
a counter portion is formed near a groove bottom of the inner raceway surface, the counter portion has a diameter larger than a groove bottom diameter by a predetermined clearance;
the counter portion is formed by a cylindrical portion and a tapered portion, the cylindrical portion axially extends from the inner raceway surface, the tapered portion reduces from the cylindrical portion toward a smaller end face of the inner ring; and
a transition portion, between the counter portion and the inner raceway surface, is smoothly formed by an arc with a radius of curvature 2.0-10.0 mm.

2. The wheel bearing of claim 1, wherein the clearance of the counter portion is set within a range of 30-90 μm.

3. The wheel bearing of claim 1, wherein a transition portion between the cylindrical portion of the counter portion and the tapered portion is smoothly formed by an arc, and the inclined angle of the tapered portion is set at an angle of 5° or less.

4. The wheel bearing of claim 1, wherein the counter portion is integrally simultaneously ground with the inner raceway surface by a formed grinding wheel.

5. The wheel bearing of claim 4, wherein the larger outer circumference and the smaller end face of the inner ring are simultaneously ground by a formed grinding wheel.

6. The wheel bearing of claim 1, wherein a counter portion, with an inner diameter slightly smaller than a grove bottom diameter, is formed on the outer member at a position spaced apart a predetermined distance from a groove bottom of the outer raceway surface, the inner diameter of the counter portion is set within a range so that balls held by the cages do not fall out from the cages due to reduction of a circumscribed circle diameter of the balls, and a transition portion, between the counter portion and the outer raceway surface, is smoothly formed by an arc having a radius of curvature of 2.0-10.0 mm.

7. The wheel bearing of claim 6, wherein the counter portion is integrally simultaneously ground with the outer raceway surfaces by a formed grinding wheel.

8. The wheel bearing of claim 7, wherein the outer raceway surfaces and the inner circumference are simultaneously ground by a formed grinding wheel.
